(19) United States
(12) Patent Application Publication
(10) Pub. No.: US 2023/0183921 A1
(43) Pub. Date: Jun. 15, 2023

(54) Blade Element for Refiner

(71) Applicant: VALMET TECHNOLOGIES OY, Espoo (FI)

(72) Inventors: Marko Loijas, Valkeakoski (FI); Ville Ruola, Valkeakoski (FI)

(73) Assignee: VALMET TECHNOLOGIES OY, Espoo (FI)

(21) Appl. No.: 17/924,997

(22) PCT Filed: May 12, 2021
(86) PCT No.: PCT/FI2021/050354

§ 371 Date: Nov. 12, 2022

(30) Foreign Application Priority Data
May 14, 2020 (FI) 20205482

(51) Int. Cl. D21D 1/30; D21D 1/22

(52) U.S. Cl. CPC D21D 1/306; D21D 1/22

(57) ABSTRACT

A blade element (4, 8) for a refiner (1) for refining fibrous material has a first end edge (18) to be directed towards a feed of the fibrous material to be refined and a second end edge (19) to be directed towards a discharge of the refined fibrous material and a refining surface (5, 9) comprising blade bars (16) and blade grooves (17) therebetween. The refining surface (5, 9) has at least one equalizing pocket (23) extending along the refining surface (5, 9) of the blade element (4, 8) and crossing a number of the blade bars (16) and a number of the blade grooves (17) for equalizing flow of the fibrous material along the refining surface (5,9).

### CROSS REFERENCES TO RELATED APPLICATIONS

This application is a U.S. National Stage application based on PCT/FI2021/050354, filed May 12, 2021, and claims priority on FI 20205482, filed May 14, 2020, the disclosures of which are incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to refiners for refining fibrous material and especially to a blade element for a refiner for refining fibrous material.

Refiners used for refining fibrous material, such as refiners used for manufacturing mechanical pulp or in any low consistency refining, comprise typically two refining elements opposite to each other and turning relative to each other, i.e., one or both is/are rotating. The refining elements comprise refining surfaces provided with blade bars and blade grooves therebetween, the blade bars being intended to defiber and refine the material to be refined and the blade grooves being intended to convey the material to be refined forward along the refining surfaces. The refining surface of the refining element is typically formed of several blade segments fastened to a body of the respective refining element. The complete refining surface of the refining element is thus formed of the refining surfaces of several blade segments fastened next to each other in the refining element.

All processes for manufacturing pulp from lignocellulosic material produce shives as an undesired quality problem. A shive is a particle or fiber bundle or wood fragment that is produced by incomplete splitting of wood material into fibers during cooking or mechanical treatment. The shives not only contaminate the quality of the produced pulp but also deteriorate operation of some processing devices such as refiners.

In manufacturing of chemi-thermomechanical pulp (CTMP) application of low consistency refining, LC refining, is increasing. In low consistency refining the consistency of the material to be refined is less than 6%, typically between 1% and 4%. A problem of producing high-quality pulp when the particle size distribution of the pulp is very wide is pronounced in the low consistency refining, especially in terms of shive control. The shives have a tendency to block the refining surfaces, and to thereby degrade the quality of the refined material and the capacity of the refiner.

### SUMMARY OF THE INVENTION

An object of the present invention is to provide a novel blade element for a refiner for refining fibrous material, as well as a novel refiner for refining fibrous material.

The invention is based on the idea of at least one equalizing pocket that extends along the refining surface of the blade element and crosses a number of the blade bars and a number of the blade grooves for equalizing flow of the fibrous material along the refining surface.

At the equalizing pocket at least a portion of the flow of the fibrous material to be refined on the refining surface is interrupted and allowed to equalize or balance before proceeding further on the refining surface.

### BRIEF DESCRIPTION OF THE DRAWINGS

In the following the invention will be described in greater detail by means of preferred embodiments with reference to the accompanying drawings.

FIG. 1 is a schematic side view of a conical refiner in cross-section.

FIG. 2 is a schematic planar upper view of a blade element applicable to be used in the refiner of FIG. 1.

FIG. 3 is a fragmentary schematic planar upper view of a detail of the blade element of FIG. 2.

For the sake of clarity, the figures show some embodiments of the invention in a simplified manner. Like reference numerals identify like elements in the figures.

### DESCRIPTION OF THE PREFERRED EMBODIMENTS

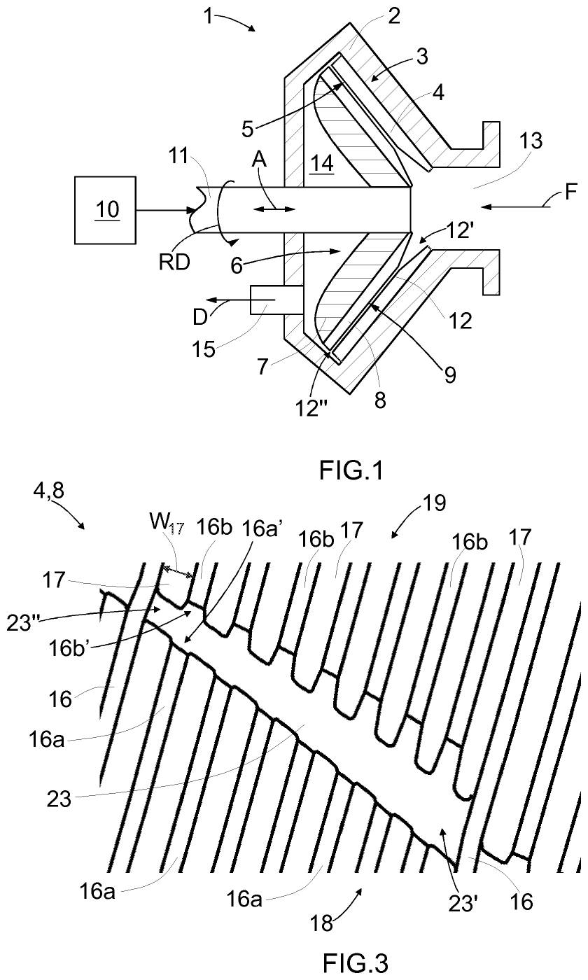

FIG. 1 shows schematically a side view of a conical refiner 1 in cross-section, which refiner may be used for refining a fibrous material, such as a wood material containing lignocellulose or another fiber material suitable to be used for manufacturing paper or paperboard, for example. The refiner 1 shown in FIG. 1 is of conical type but disc refiners, conical-disc-refiners and cylindrical refiners could be used as well as an example here. Generally, a refiner comprises at least two substantially oppositely positioned refining elements at least one of which is rotating, and a refining chamber formed between each two substantially oppositely positioned refining elements. In the following a refiner with only one rotatable refining element is described.

The refiner 1 of FIG. 1 comprises a frame 2 and a stationary, fixed refining element 3, i.e., a stator 3, supported on the frame 2. The frame 2 provides a body for the stator 3 unless the stator 3 is provided with a separate body to be fastened to the frame 2 of the refiner 1.

The stator 3 comprises one or more stator blade elements 4 comprising blade bars and blade grooves therebetween. The blade bars and the blade grooves in each one or more stator blade elements 4 form a refining surface 5 of the respective blade element 4. A complete refining surface of the stator 3 is formed either of the refining surface 5 of a single stator blade element 4 extending over the whole circumference of the stator 3 or of the refining surfaces 5 of two or more blade elements 4 having a form of a blade segment and fastened next to each other in the stator 3 so that the complete refining surface 5 extending over the whole circumference of the stator 3 is provided. In the latter case the refining surface 5 of each stator blade segment 4 provides only a part of the refining surface of the stator 3. For the sake of clarity, both the refining surface of each one or more stator blade elements 4 as well as the complete refining surface of the stator 3 are herein denoted with the same reference sign 5. Additionally, the same reference sign 4 may be used to denote a segment-like blade element for the stator 3 as well as a single blade element extending over the whole circumference of the stator 3.

The refiner 1 further comprises a rotatable refining element 6, i.e., a rotor 6 of the refiner 1. The rotor 6 comprises a hub 7. The rotor 6 further comprises one or more rotor blade elements 8 supported to the hub 7, each one or more rotor blade elements 8 comprising blade bars and blade grooves therebetween. The blade bars and the blade grooves in each one or more rotor blade elements 8 form a refining surface 9 of the respective blade element 8. A complete refining surface of the rotor 6 is formed either of the refining surface 9 of a single rotor blade element 8 extending over the whole circumference of the rotor 6 or of the refining surfaces 9 of two or more blade elements 8 having a form of a blade segment and fastened next to each other in the rotor 6 so that the complete refining surface 9 extending over the whole circumference of the rotor 6 is provided. In the latter case the refining surface 9 of each rotor blade segment 8 provides only a part of the refining surface of the rotor 6. For the sake of clarity, both the refining surface of each one or more rotor blade elements 8 as well as the complete refining surface of the rotor 6 are herein denoted with the same reference sign 9. Additionally, the same reference sign 8 may be used below to denote a segment-like blade element for the rotor 6 as well as a single blade element extending over the whole circumference of the rotor 6.

The hub 7 of the rotor 6 is connected to a driving motor 10 by a shaft 11 so that the rotor 6 can be rotated relative to the stator 3 in a direction of arrow RD, for instance, the arrow RD thus indicating an intended rotation direction 5 RD of the rotor 6.

The refiner 1 may also comprise a loading device which, for the sake of clarity, is not shown in FIG. 1. The loading device can be used for moving back and forth the rotor 6 attached to the shaft 11, as schematically shown by arrow A, in order to adjust a size of a refining gap 12, i.e., a refining chamber 12, between the stator 3 and the rotor 6, wherein the fibrous material is actually refined. A structure and operation of different applicable loading devices are generally known for a person skilled in the art of refining and are therefore not disclosed herein in more detail.

The fibrous material to be refined is fed into the refiner 1 via a feed channel 13 in a manner shown by arrow F. The fibrous material fed into the refiner 1 passes into the refining chamber 12 through a first end 12′ or a feed end 12′ of the refining chamber 12 having the smaller diameter. In the refining chamber 12 the fibrous material is defibrated and refined while the water contained in the material vaporizes. The already refined fibrous material flows away from the refining chamber 12 through a second end 12″ or a discharge end 12″ of the refining chamber 12 having the larger diameter into a discharge chamber 14 wherefrom the refined material is removed via a discharge channel 15 from the refiner 1, as schematically shown by arrow D.

It is emphasized that in addition to the conical refiners the blade element of the solution described herein is applicable to disc refiners and cylindrical refiners and to refiners comprising both a conical portion and a disc portion, as well.

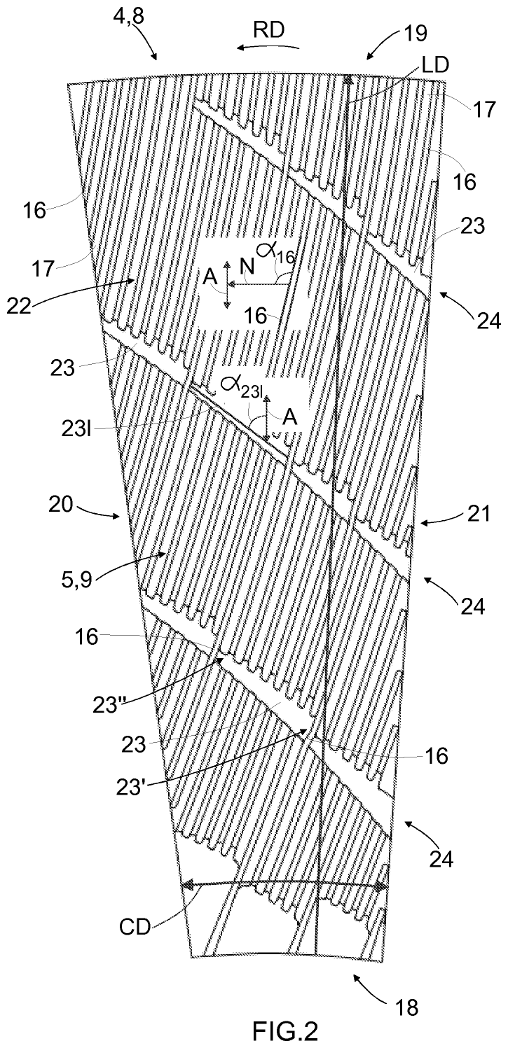

FIG. 2 is a schematic planar upper view of a blade element 4, 8, having a form of a blade segment 4, 8, applicable to be used for forming a part of the refining surface 5, 9 of the stator 3 or the rotor 6, whereby the complete refining surface 5, 9 is provided by arranging the necessary number of the blade segments 4, 8 of FIG. 2 next to each other around a circumference of the stator 3 or the rotor 6. The embodiments of the blade element disclosed below are to the appropriate extent applicable to the single blade elements extending over the whole circumference of the stator 3 or of the rotor 6 as well. FIG. 3 is a schematic planar upper view of a detail of the blade element of FIG. 2.

The blade segment 8 comprises, on a front surface 22 thereof, the refining surface 5, 9 provided with blade bars 16 and blade grooves 17 therebetween, the blade bars 16 and the blade grooves 17 extending along the front surface 22 of the blade segment 4, 8. The blade bars 16 and the blade grooves 17 have a longitudinal direction and a width direction, or a lateral direction, substantially crosswise to the longitudinal direction thereof. The blade bars 16 are intended to defiber and refine the material to be refined and the blade grooves 17 are intended to convey the material forward along the refining surface 5, 9.

The blade segment 4, 8 comprises an inner end edge 18 or a first end edge 18 or a feed end edge 18 to be directed towards the first end 12′ of the refining chamber 12, i.e., towards an end of the refining element 3, 6 having the smaller diameter. The fibrous material to be refined is fed or supplied onto the refining surface 5, 9 over the first end edge 18.

The blade segment 4, 8 further comprises an outer end edge 19 or a second end edge 19 or a discharge end edge 19 to be directed towards the second end 12″ of the refining chamber 12, i.e., towards an end of the refining element 3, 6 having the larger diameter. The refined fibrous material is discharged from the refining surface 5, 9 over the second end edge 19.

In conical and cylindrical refiners the inner end edge 18 of the blade segment 4, 8 provides an axially inner end 18 of the blade segment 4, 8 and the outer end edge 19 of the blade segment 4, 8 provides an axially outer end 19 of the blade segment 4, 8, the direction from the axially inner end 18 towards the axially outer end 19 providing the axial direction of the blade segment 4, 8. In disc refiners the inner end edge of the blade segment would be a radially inner end of the blade segment and the outer end edge of the blade segment would be a radially outer end of the blade segment, the direction from the radially inner end towards the radially outer end thus providing the radial direction of the blade segment. In other words, the blade segment 4, 8 has a longitudinal direction extending between the inner end edge 18 and the outer end edge 19, as denoted in FIG. 2 with a schematically shown arrow LD extending from the inner end edge 18 up to the outer end edge 19 of the blade segment 4, 8. When the blade segment 4, 8 is mounted in a refiner, the longitudinal direction LD of the blade segment 4, 8 or a projection thereof is substantially parallel to an axial direction of the refiner in case of cylindrical and conical refiners and substantially parallel to a radial direction of the refiner in case of disc refiners. For the blade segments 4, 8 intended to the conical and cylindrical refiners the longitudinal direction LD of the blade segment 4, 8 thus corresponds to the above-mentioned axial direction of the blade segment 4, 8 and for the blade segments 4, 8 intended to disc refiners the longitudinal direction LD of the blade segment 4, 8 thus corresponds to the above-mentioned radial direction of the blade segment 4, 8.

The blade segment 4, 8 further comprises a first side edge 20 or a leading side edge 20 extending from the inner end edge 18 of the blade segment 4, 8 up to the outer end edge 19 of the blade segment 4, 8. The first side edge 20 is the edge of the blade segment 4, 8 that first meets the edge of a counter blade segment during the rotation of the rotor 6. So, in the rotor 6 it provides the side edge of the blade segment 8 to be directed towards the intended rotation direction RD of the rotor 6 and in the stator 3 it provides the side edge of the blade segment 4 to be directed to opposite direction relative to the intended rotation direction RD of the rotor 6.

The blade segment 4, 8 further comprises a second side edge 21 or a trailing side edge 21 opposite to the first side edge 20 and extending from the inner end edge 18 of the blade segment 4, 8 up to the outer end edge 19 of the blade segment 4, 8. The second side edge 21 is thus, in turn, the edge of the blade segment 4, 8 that last meets the edge of a counter blade segment during the rotation of the rotor 6. So, in the rotor 6 it provides the side edge of the blade segment 8 to be directed to the opposite direction relative to the intended rotation direction RD of the rotor 6 and in the stator 3 it provides to be directed towards the intended rotation direction RD of the rotor 6. In the embodiment of FIG. 2 the first 20 and second 21 side edges are straight, but they could also be curved as well. The direction of the blade segment 4, 8 extending between the first side edge 20 and the second side edge 21 perpendicularly to the longitudinal direction LD of the blade segment 4, 8 is a circumferential direction CD of the blade segment 4, 8. The circumferential direction CD of the blade segment 4, 8 thus forms a normal N to the longitudinal direction LD of the blade segment 4, 8.

The inner end edge 18 and the outer end edge 19 together with the first 20 and second 21 side edges define a periphery of the blade segment 4, 8.

The refining surface 5, 9 of the blade segment 4, 8 further comprises a number of equalizing pockets 23, i.e. at least one equalizing pocket 23 or one or more equalizing pockets 23 that extend(s) along the refining surface 5, 9 of the blade segment 4, 8. The equalizing pockets 23 are portions of the refining surface 5, 9 at which the flow of the fibrous material along the refining surface 5, 9 is allowed to equalize or balance before proceeding again forward along the refining surface 5, 9. The equalizing pocket 23 has a first end 23′ and a second end 23″, the equalizing pocket 23 thus having a longitudinal direction or a direction of extension in the direction between the first end 23′ and the second end 23″, the longitudinal direction of the equalizing pocket 23 being shown schematically in FIG. 2 by a line denoted with the reference sign 231. The equalizing pocket 23 begins at the first end 23′ from a blade bar 16, extends over one or more blade bars 16 and its/their neighboring blade grooves 17 crossing those all, and ends at the second end 23″ to another blade bar 16. A start point or an end point of an equalizing pocket 23 may locate on a neighboring blade segment 4, 8.

The equalizing pocket 23 is arranged to cross, along its longitudinal direction 231, a number of the blade bars 16 and a number of the blade grooves 17, i.e., at least one blade bar 16 or one or more blade bars 16 and the respective blade grooves 17 surrounding and/or remaining between the number of the blade bars 16. Therefore, in its minimum, the equalizing pocket 23 may be arranged to cross one blade bar 16, whereby the equalizing pocket 23 is arranged to extend over the single blade bar 16 and the blade grooves 17 on both sides of the blade bar 16. However, typically, the equalizing pocket 23 is arranged to cross at least two blade bars 16, whereby the equalizing pocket 23 is arranged to extend over the at least two blade bars 16 and the blade grooves 17 between the at least two blade bars 16 as well as the blade grooves 17 surrounding the outermost blade bars 16 in the direction of the extension 231 of the equalizing pocket 23. In the embodiment of FIG. 2, the equalizing pockets 23 are arranged to extend over four to seven blade bars 16 depending on a position of each equalizing pocket 23 in the refining surface 5, 9 of the blade segment 4, 8. The number of the blade bars 16 crossed by the pocket 23 can be from one blade bar 16 up to any number, however, in such a way that at least one pocket 23 is formed between the side edges 20, 21 of the blade segment 4, 8.

An effect of the at least one equalizing pocket 23 is to provide an intentional or a purposeful break in otherwise substantially continuous course or run of the at least one blade bar 16 and the respective blade grooves 17, whereby at least a portion of the flow of the fibrous material to be refined on the refining surface 5, 9 from a direction of the first end edge 18 of the blade segment 4, 8 towards the second end edge 19 of the blade segment 4, 8 is interrupted and allowed to equalize or balance and re-mix at the equalizing pocket 23 before proceeding further towards the second end edge 19 of the blade segment 4, 8. An angle α₂₃₁ between the longitudinal direction 231 of the equalizing pocket 23 and an axial direction A or a radial direction of the blade segment 4, 8 is over 0 degrees but less than 90 degrees, preferably 10-80 degrees, and more preferably 30-80 degrees. The longitudinal direction 231 of the equalizing pocket 23 is thus arranged to deviate from an axial/radial direction A of the blade segment 4, 8 and from a direction of a normal N of the axial/radial direction A of the blade segment 4, 8. The axial/radial direction A of the blade segment 4, 8 and the direction of the normal N of the axial/radial direction A of the blade segment 4, 8 are shown schematically in FIG. 2.

In the embodiment of FIG. 2 each equalizing pocket 23 is arranged to cross the respective blade bars 16 and the blade grooves 17 at an angle of about 90 degrees. Therefore, in the embodiment of FIG. 2 a crossing angle between the longitudinal direction 231 of the equalizing pocket 23 and the blade bars 16 is about 90 degrees. Generally, the crossing angle between the longitudinal direction of the equalizing pocket 23 and the blade bar 16 may be from 90±50 degrees. The effect of this angle range is that the direction of extension of the equalizing pocket 23 deviates from the direction of the blade bars 16 and the blade grooves 17 to such an extent that it is ensured that at least a portion of the flow of the fibrous material is interrupted and allowed to stabilize and then re-mix at the equalizing pocket 23 before proceeding further towards the second end edge 19 of the blade segment 4, 8, thus enabling better treatment of shives.

The longitudinal direction 231 of the equalizing pocket 23 is thus arranged to deviate from the direction of the blade bars 16 as well as from the axial/radial direction A of the blade segment 4, 8 and its normal line N.

The refining surface 5, 9 of the blade segment 4, 8 of FIG. 2 comprises altogether three series 24 of consecutively and substantially correspondingly oriented equalizing pockets 23, wherein the ends 23′, 23″ of the consecutively arranged equalizing pockets 23 in the series 24 of the equalizing pockets 23 are separated from each other by a single blade bar 16. Each series 24 of the consecutively and substantially correspondingly oriented equalizing pockets 23 are arranged to extend over at least a portion of the refining surface 5, 9 from a direction of the second side edge 21 of the blade segment 4, 8 towards the first side edge 20 of the blade segment 4, 8.

Generally, the refining surface 5, 9 of the blade segment 4, 8 may comprise at least one series 24 of at least two consecutively and substantially correspondingly oriented equalizing pockets 23, wherein each series 24 of the equalizing pockets 23 is arranged to extend over at least a portion of the refining surface 5, 9 and wherein the ends 23′, 23″ of the at least two consecutively arranged equalizing pockets 23 are separated from each other by at least one blade bar 16. With the pockets 23 closest to the side edges 20, 21, the first or last pocket 23 of a pocket series 24, the separating blade bar 16 may be and usually is located on a neighboring blade segment 4, 8.

The at least one series 24 of the equalizing pockets 23 arranged to extend over at least a portion of the refining surface 5, 9 of the blade segment 4, 8 provides an equalizing or balancing effect of the flow of the fibrous material to take place effectively on a larger portion of the refining surface 5, 9 of the blade segment 4, 8 in a circumferential direction thereof when compared to possibly totally separate equalizing pockets 23 decentralized at random locations in the refining surface 5, 9.

The number of the series of the pockets 23 can be several. In FIG. 2 there are three series 24 in parallel orientation, but mutual orientation of the series could be non-parallel as well, for example such that the series 24 closer to the outer end edge 19 could be oriented in steeper crossing angle with respect to the series 24 locating more inner.

The effect of the feature that the ends 23′, 23″ of the consecutively arranged equalizing pockets 23 in the series 24 of the equalizing pockets 23 are separated from each other by at least one blade bar 16 is, in turn, that the flow of the fibrous material in at least partly circumferential direction of the blade segment 4, 8 along the equalizing pockets 23 is interrupted at some point, i.e., excessive flow of the fibrous material in at least a partly circumferential direction of the blade segment 4, 8 is not allowed, and the fibrous material is thereby forced to flow again mainly towards the discharge end edge 19 of the blade segment 4, 8, thus also preventing a clogging of the refining surface 5, 9 of the blade segment 4, 8. The at least one blade bar 16 between two consecutive equalizing pockets 23 thus provides an element that separates two consecutive equalizing pockets 23 from each other in a longitudinal direction of the series 24 of the equalizing pockets 23 or terminates the equalizing pocket 23 at the respective end 23′, 23″ thereof.

Furthermore, referring to the embodiment of FIG. 2, the series 24 of the equalizing pockets 23 are arranged at the refining surface 5, 9 at an angle that deviates from the direction of the normal N of the axial/radial direction A of the blade segment 4, 8. Thus, the pockets 23 are distributed more uniformly over the axial/radial length of the refining surface instead of being located on the same axial/radial position. Generally, according to an embodiment, at least one series of at least two equalizing pockets is arranged at the refining surface at an angle deviating from the direction of the normal N of the axial/radial direction A of the blade element. This has several benefits. Material flow towards the discharge end edge 19 is not hindered but is maintained or improved, also wear of the blade element is more uniform. Furthermore, pressure variations that possibly appear during operation of the refiner may be avoided.

The blade segment 4, 8 disclosed has a specific intended orientation for installing it in the refiner 1, at which orientation the blade bars 16 and the blade grooves 17 are arranged relative to the intended rotation direction RD of the rotor 6 of the refiner 1 at such an angle that promotes the flow of the fibrous material towards the second end edge 19 of the blade segment 4, 8. At the same time the at least one equalizing pocket 23 is arranged relative to the intended rotation direction RD of the rotor 6 of the refiner 1 at such an angle that resists the flow of the fibrous material towards the second end edge 19 of the blade segment 4, 8. In the implementation of the embodiment of FIG. 2 this is performed by arranging the blade bars 16, and respectively the blade grooves 17, such that an angle α₁₆ between the normal N relative to the axial direction A or radial direction of the blade segment 4, 8 and the blade bar 16, or a tangent of the blade bar 16, on the side of the leading edge 20 is larger than 90 degrees. In other words, the bars/grooves 16, 17 and a pocket 23 or a series 24 of the pockets 23 are mutually tilted to opposite directions with respect to the direction A, which equals the axial direction in case of a conical/cylindrical refiner or the radial direction in case of a disc refiner.

By arranging the blade bars and respectively the blade grooves relative to the intended rotation direction RD of the rotor of the refiner at an angle promoting the flow of the fibrous material towards the second end edge of the blade element, it is ensured that the fibrous material to be refined has a general flow direction towards the discharge end edge of the blade element, thereby preventing the blocking of the refining surface by the fibrous material to be refined. However, by arranging the at least one equalizing pocket relative to the intended rotation direction RD of the rotor of the refiner at an angle resisting the flow of the fibrous material towards the discharge end edge of the blade element, such an effect is, however, subjected to at least a portion of the flow of the fibrous material that shortly interrupts the flow of material towards the discharge end edge of the blade element and allows it to equalize or balance before proceeding further towards the discharge end edge of the blade element.

According to an embodiment of the equalizing pocket 23, a volume of the equalizing pocket 23 is arranged to decrease from the first end 23′ of the equalizing pocket 23 towards the second end 23″ of the equalizing pocket 23. The decreasing volume of the equalizing pocket 23 from the first end 23′ towards the second end 23″ forces the fibrous material entered into the equalizing pocket 23 to exit the equalizing pocket 23 towards the discharge end edge 19 of the blade segment 4, 8 after being equalized or balanced in the equalizing pocket 23.

The decreasing volume of the equalizing pocket 23 from the first end 23′ towards the second end 23″ may be achieved by arranging at least one of a width and a depth of the equalizing pocket 23 to decrease from the first end 23′ of the equalizing pocket 23 towards the second end 23″ of the equalizing pocket 23. In other words, the width and/or the depth of the equalizing pocket 23 may be arranged to decrease from the first end 23′ of the equalizing pocket 23 towards the second end 23″ thereof.

The width of the equalizing pocket 23 refers to a measure of the equalizing pocket 23 that is substantially crosswise to the direction between the first end 23′ and the second end 23″ of the equalizing pocket 23 and may be determined as a distance between an end 16a′ of a blade bar 16a extending from a direction of the first end edge 18 of the blade segment 4, 8 towards the equalizing pocket 23 in question and an end 16b′ of another blade bar 16b that extends from the equalizing pocket 23 in question at least partly towards the second end edge 19 of the blade segment 4, 8 and is substantially opposite to the herein first mentioned blade bar 16a (FIG. 3).

The depth of the equalizing pocket 23 may be determined as a vertical distance between a bottom of the equalizing pocket 23 and a level of a top surface of the blade bar 16.

According to an embodiment of the equalizing pocket 23, at least one of the width and the depth of the equalizing pocket 23 is arranged to decrease dynamically from the first end 23′ of the equalizing pocket 23 towards the second end 23″ of the equalizing pocket 23. In other words, the width and/or the depth of the equalizing pocket 23 is arranged to decrease dynamically, i.e., in a substantially continuous manner, from the first end 23′ of the equalizing pocket 23 towards the second end 23″ of the equalizing pocket 23, whereby the fibrous material entered into the equalizing pocket 23 is forced to flow away from the equalizing pocket 23 further towards the discharge end edge 19 of the blade segment 4, 8 in a substantially even manner, without causing undesirable turbulences in the flow of the fibrous material. Stepwise decrease of the width and/or the depth of the equalizing pocket 23 is of course possible but less preferable.

Referring again to the embodiment of FIG. 2, the equalizing pockets 23 are arranged at the refining surface 5, 9 of the blade segment 4, 8 at an angle relative to the first end edge 18 and the second end edge 19 of the blade segment 4, 8 such that the first end 23′ of the equalizing pocket 23 is closer to the first end edge 18 of the blade segment 4, 8 than the second end 23″ of the equalizing pocket 23. This embodiment, especially together with the decreasing volume of the equalizing pocket 23 towards the second end 23″ thereof, has an effect according to which the fibrous material entered into the equalizing pocket 23 is forced to continue the flow towards the outer end edge 19 of the blade segment 4, 8. This kind of alignment of the equalization pockets 23 leads also to the alignment of the series 24 of the equalization pockets 23, wherein one end of the series 24 of the equalization pockets 23 is closer to the first end edge 18 of the blade segment 4, 8 and the other end of the series 24 of the equalization pockets 23 is closer to the second end edge 19 of the blade segment 4, 8. The series 24 of the equalization pockets 23 is thus aligned or directed at least partly towards the second end edge 19 of the blade segment 4, 8.

Furthermore, in the embodiment of FIG. 2, a volume of the equalizing pockets 23 remaining closer to the second end edge 19 of the blade segment 4, 8 are arranged to be smaller than a volume of the equalizing pockets 23 remaining closer to the first end edge 18 of the blade segment 4, 8. Generally, according to an embodiment of the blade element, a volume of at least one equalizing pocket remaining closer to the second end edge of the blade element is arranged to be smaller than a volume of at least one other equalizing pocket remaining closer to the first end edge of the blade element. This has the effect that a dwell time of the fibrous material entered into the equalizing pocket 23 decreases towards the discharge end 12″ of the refining chamber 12, the flow of the fibrous material towards the discharge end 12″ of the refining chamber 12 thereby being more effective close to the discharge end 12″ of the refining chamber 12.

According to an embodiment of the blade segment 4, 8, referring especially to FIG. 3, widths W₁₇ of the blade grooves 17 extending from the equalizing pocket 23 at least partly towards the second end edge 19 of the blade segment 4, 8 are arranged to increase in the direction from the first end 23′ of the equalizing pocket 23 towards the second end 23″ of the equalizing pocket 23. In general terms it may therefore be determined that the equalizing pocket 23 has a first end 23′ and a second end 23″ and that widths W₁₇ of the blade grooves 17 extending from the at least one equalizing pocket 23 at least partly towards the second end edge 19 of the blade element 4, 8, i.e., of those grooves 17 that are crossed by the pocket 23, are arranged to increase in a direction from the first end 23′ of the equalizing pocket 23 towards the second end 23″ of the equalizing pocket 23. The widths W₁₇ of the blade grooves 17 are arranged to increase substantially continuously at the equalizing pocket 23 such that the blade groove 17 at the first end 23′ of the equalizing pocket 23 is the narrowest one and the blade groove 17 at the second end 23″ of the equalizing pocket 23 is the widest one and that each blade groove 17 closer to the second end 23″ of the equalizing pocket 23 is at least little bit wider than the blade groove 17 closer to the first end 23′ of the equalizing pocket 23. The varying width of the grooves 17 enables fibers/shives/particles of different sizes to redistribute to grooves 17 corresponding their sizes, when the material flow has stabilized at the equalization pocket 23. Widening of the grooves 17 in this order, i.e., from the first end 23′ towards the second end 23″ is beneficial to ensure smooth flow of particles. In case of reverse order, the widest groove could be filled with the smaller particles and the shives with bigger size could not find an exit that fits for them. The width W₁₇ of the blade groove 17 at the first end 23′ of the equalizing pocket 23 may for example be 1-5 mm and the width W₁₇ of the blade groove 17 at the second end 23″ of the equalizing pocket 23 may for example be 5-10 mm.

The increasing width of the blade grooves 17 towards the second end 23″ of the equalizing pocket 23 ensures that also shives of bigger size entered into the equalizing pocket 23 are able to exit the equalizing pocket 23 and thereby are able to be defibered and refined and not to block the refining surface 5, 9. This embodiment, especially together with the decreasing volume of the equalizing pocket 23 towards the second 23″ thereof, effectively ensures that the pulp flow is forced to mix again, thus forcing the material including chives to exit the equalizing pocket 23 and flow towards the outer end edge 19 of the blade element 4, 8.

It will be obvious to a person skilled in the art that, as the technology advances, the inventive concept can be implemented in various ways. The invention and its embodiments are not limited to the examples described above but may vary within the scope of the claims.

1-12. (canceled)

13. A blade element for a refiner of chemi-thermomechanical pulp of consistency of less than 6% with a particle size distribution that includes shives which block the refining surfaces, the blade element comprising:
a feed end edge arranged to receive a feed of the fibrous material to be refined and a discharge end edge arranged to discharge of the fibrous material as refined fibrous material; and
a refining surface comprising blade bars and blade grooves therebetween;
wherein the discharge end edge, when the blade element is mounted in the refiner, rotates in a circumferential direction about an axis of rotation, the blade element having a longitudinal direction from the feed end edge to the discharge end edge which is parallel to the axis of rotation or passes through the axis of rotation;
wherein the blade element has portions of the refining surface at which flow of the fibrous material along the refining surface is allowed to equalize by extending through at least one equalizing pocket which extends along the refining surface of the blade element and crosses a plurality of the blade bars and a plurality of the blade grooves thus equalizing flow of the fibrous material along the refining surface;
wherein the at least one equalizing pocket begins at a first end at a first blade bar and extends in a longitudinal direction of the equalizing pocket and in the circumferential direction over the plurality of the blade bars and the plurality of the blade grooves and ending at a second end at a second blade bar;
wherein the longitudinal direction of the equalizing pocket is arranged to deviate from: a direction in which the blade bars extend, from a longitudinal direction of the blade element, and from a direction of a normal to the longitudinal direction of the blade element; and
wherein the equalizing pocket in the longitudinal direction of the equalizing pocket has a cross-sectional area which decreases from the first end of the equalizing pocket to the second end of the equalizing pocket.

14. The blade element of claim 13 wherein an angle between the longitudinal direction of the equalizing pocket and the longitudinal direction of the blade element is greater than 0 degrees and less than 90 degrees.

15. The blade element of claim 14 wherein the angle between the longitudinal direction of the equalizing pocket and the longitudinal direction of the blade element is between 10-80 degrees.

16. The blade element of claim 15 wherein the angle between the longitudinal direction of the equalizing pocket and the longitudinal direction of the blade element is between 30-80 degrees.

17. The blade element of claim 13 wherein the angle between the longitudinal direction of the equalizing pocket and the blade bars is between 40-140 degrees.

18. The blade element of claim 13 wherein the refining surface comprises at least one series of at least two consecutively and substantially correspondingly oriented equalizing pockets wherein each series of the equalizing pockets is arranged to extend over at least a portion of the refining surface and wherein ends of the at least two consecutively arranged equalizing pockets in each series of the equalizing pockets are separated from each other by at least one blade bar.

19. The blade element of claim 1 further comprising a second equalizing pocket which is closer to the second end edge than the equalizing pocket, and wherein a volume of the second equalizing pocket is smaller than a volume of the equalizing pocket which is closer to the first end edge of the blade element.

20. The blade element of claim 1 wherein a plurality of blade grooves extend from the equalizing pocket and have widths, and wherein the widths of the blade grooves extending from the equalizing pocket at least partly towards the second end edge of the blade element are arranged to increase in a direction from the first end of the equalizing pocket towards the second end of the equalizing pocket.

21. A blade element for a refiner for refining fibrous material, the blade element for mounting within the refiner to rotate in a circumferential direction, the blade element comprising:
a first end edge to be directed towards a feed of the fibrous material to be refined and a second end edge to be directed towards a discharge of the refined fibrous material, wherein a blade element longitudinal direction is defined extending from the first end edge to the second end edge, and
a refining surface comprising blade bars and blade grooves therebetween, wherein the refining surface comprises an equalizing pocket extending along the refining surface of the blade element and crossing a plurality of the blade bars and a plurality of the blade grooves for equalizing flow of the fibrous material along the refining surface, the equalizing pocket beginning at a pocket first end adjacent a first blade bar of the plurality of blade bars, and extending over a plurality of blade bars and their neighboring blade grooves, and ending at a second end at a second blade bar of the plurality of blade bars, wherein the second blade bar is spaced from the first blade bar in the circumferential direction;
wherein a pocket longitudinal direction is defined along the center of the equalizing pocket extending from the first blade bar to the second blade bar, the pocket longitudinal direction deviating from the direction of the blade bars and from the blade element longitudinal direction and from a direction normal to the blade element longitudinal direction;
wherein at any point within the equalizing pocket along the pocket longitudinal direction, the equalizing pocket has a depth measured below a height of the blade bars, and a width measured normal to the pocket longitudinal direction, and wherein the product of the depth and the width is an area which decreases as the equalizing pocket continues from the first blade bar to the second blade bar, such that the volume of the equalizing pocket for any given length along the pocket longitudinal direction decreases with progression from the first blade bar to the second blade bar.

22. The blade element of claim 21 wherein at least one of the width and the depth of the equalizing pocket is arranged to decrease dynamically from the first end of the equalizing pocket towards the second end of the equalizing pocket.

23. The blade element of claim 21 wherein the equalizing pocket is arranged at an angle relative to the first end edge and the second end edge of the blade element such that the first end of the equalizing pocket is closer to the first end edge of the blade element than the second end of the equalizing pocket.

24. The blade element of claim 21 further comprising a second equalizing pocket which is closer to the second end edge than the equalizing pocket, and wherein a volume of the second equalizing pocket is smaller than a volume of the equalizing pocket which is closer to the first end edge of the blade element.

25. The blade element of claim 21 wherein a plurality of blade grooves extend from the equalizing pocket and have widths, and wherein the widths of the blade grooves extending from the equalizing pocket at least partly towards the second end edge of the blade element are arranged to increase in a direction from the first end of the equalizing pocket towards the second end of the equalizing pocket.

26. The blade element of claim 21 wherein an angle between the longitudinal direction of the equalizing pocket and the longitudinal direction of the blade element is greater than 0 degrees and less than 90 degrees.

27. The blade element of claim 21 wherein the refining surface comprises at least one series of at least two consecutively and substantially correspondingly oriented equalizing pockets wherein each series of the equalizing pockets is arranged to extend over at least a portion of the refining surface and wherein ends of the at least two consecutively arranged equalizing pockets in each series of the equalizing pockets are separated from each other by at least one blade bar.
